(19) United States
(12) Patent Application Publication
(10) Pub. No.: US 2003/0197512 A1
(43) Pub. Date: Oct. 23, 2003

(54) Battery analyzer

(76) Inventors: Michael Miller, Mason City, IA (US); Nathan Meyer, Mason City, IA (US); Michael Frank, Clear Lake, IA (US)

Correspondence Address: KENYON & KENYON, ONE BROADWAY, NEW YORK, NY, 10004, US

(21) Appl. No.: 10/131,794

(22) Filed: Apr. 22, 2002

(51) Int. Cl. G01N 27/416

(52) U.S. Cl. 324/426

(57) ABSTRACT

A battery analyzer, including a network interface arrangement configured to communicatively couple to a computer network, a battery interface arrangement configured to electrically connect to at least one battery arrangement, each of the at least one battery arrangement including a battery, and a processing arrangement disposed within the base unit and electrically connected to the network interface arrangement and the battery interface arrangement, in which the processing arrangement is configured to charge and discharge the battery of each of the at least one battery arrangement via the battery interface arrangement and is configured to initiate a performance sequence.

### FIELD OF THE INVENTION

The present invention relates to battery analyzers and battery chargers.

### BACKGROUND INFORMATION

Battery adapters and analyzers permit a user to charge, discharge, and test the performance of a rechargeable battery. However, conventional adapters and analyzers cannot communicate information concerning the battery to a device in a remote location.

Conventional adapters and analyzers cannot receive information from a remote location, such as marketing information, software updates for the battery analyzer, software updates for the battery arrangement, user manuals, technical support data, product catalog information, battery specifications data, advertising information, and/or parameter information.

Moreover, conventional adapters and analyzers may not be used to communicate information to a device in a remote location, such as product orders, user inquiries, and/or user requests.

### SUMMARY

In an exemplary embodiment according to the present invention, a battery analyzer is provided, which includes a network interface arrangement configured to communicatively couple to a computer network, a battery interface arrangement configured to electrically connect to at least one battery arrangement, each of the at least one battery arrangement including at least one battery, and a processing arrangement electrically and communicatively coupled to the network interface arrangement and the battery interface arrangement, in which the processing arrangement is configured to communicate first information concerning the at least one battery to at least one remote device via the computer network.

In another exemplary embodiment according to the present invention, a battery analyzer is provided, which includes a network interface arrangement configured to communicatively couple to a computer network, a battery interface arrangement configured to electrically connect to at least one battery arrangement, each of the at least one battery arrangement including a battery, and a processing arrangement electrically and communicatively coupled to the network interface arrangement and the battery interface arrangement, in which the processing arrangement is configured to communicate first information concerning a diagnosis of the at least one battery to at least one remote device via the computer network.

In still another exemplary embodiment according to the present invention, a battery analyzer is provided, which includes a network interface arrangement configured to communicatively couple to a computer network, a battery interface arrangement configured to electrically connect to at least one battery arrangement, each of the at least one battery arrangement including a battery, and a processing arrangement electrically and communicatively coupled to the network interface arrangement and the battery interface arrangement, in which the processing arrangement is configured to control at least one of a charging and a discharging of the at least one battery as a function of information received from at least one remote device via the network interface.

In yet another exemplary embodiment according to the present invention a battery analyzer system is provided, which includes a computer network, a battery analyzer including a network interface arrangement communicatively coupled to the computer network, a battery interface arrangement configured to electrically connect to at least one battery arrangement, each of the at least one battery arrangement including a battery, and a processing arrangement electrically and communicatively coupled to the network interface arrangement and the battery interface arrangement, and at least one remote device communicatively coupled to the computer network; wherein the processing arrangement of the battery analyzer is configured to communicate first information concerning the at least one battery to the least one remote device via the computer network.

In yet another exemplary embodiment according to the present invention a customer service site is provided, which includes a network interface arrangement configured to communicatively couple to a computer network, and a processing arrangement electrically and communicatively coupled to the network interface arrangement, in which the processing arrangement is configured to communicate first information concerning the at least one battery to the at least one battery analyzer via the computer network, and the processing arrangement is further configured to receive second information concerning at least one battery from at least one battery analyzer via the computer network.

### BRIEF DESCRIPTION OF THE DRAWINGS

FIG. 1 illustrates a battery analyzer system according to the present invention.

FIG. 2a illustrates another exemplary battery analyzer system of the type illustrated in FIG. 1, in which a selected one of at least one remote device includes a centralized computer for collecting and distributing information to a customer service site.

FIG. 2b is a flow diagram of data communication between the battery analyzer and the customer service site illustrated in FIG. 2a.

FIG. 2c is a flow diagram of data communication between the battery analyzer and the customer service site illustrated in FIG. 2a, in which the usage, performance, and technical support information indicate that the battery analyzer and/or the battery arrangement is defective.

FIG. 3a illustrates another exemplary battery analyzer system of the type illustrated in FIG. 2, in which the at least one remote device includes a centralized computer and a plurality of additional battery analyzers.

FIG. 3b illustrates the exemplary battery analyzer system of FIG. 3a, in which the at least one remote device includes at least one respective battery analyzer.

FIG. 4a is an illustration the battery analyzer of FIGS. 1, 2a, 3a, and 3b.

FIG. 4b illustrates the electrical connectivity between the battery arrangement of FIG. 4a and a battery analyzer.

FIG. 5 illustrates an exemplary embodiment of a battery adapter according to the present invention.

FIG. 6 is a block diagram of the battery analyzer illustrated in FIGS. 1, 2a, 3a, and 3b.

FIG. 7a illustrates further detail of the exemplary battery interface arrangement of FIG. 6.

FIG. 7b illustrates further detail of a variant of the battery interface arrangement of FIG. 6 operable to communicatively couple to a smart battery.

FIG. 8 illustrates further detail of the reverse-battery protection arrangement of FIGS. 7a and 7b.

FIG. 9 illustrates further detail of the exemplary processing arrangement of FIG. 6.

FIG. 10 is a flow diagram of an exemplary performance sequence executed by the processing arrangement.

FIG. 11 is a block diagram of an operational sequence for charging a battery.

FIG. 12 is a block diagram of an operational sequence for discharging a battery.

FIG. 13 is a block diagram of an operational sequence for replacing program code of a battery arrangement.

FIG. 14 is a block diagram of data communication between the battery analyzer and a remote device.

### DETAILED DESCRIPTION

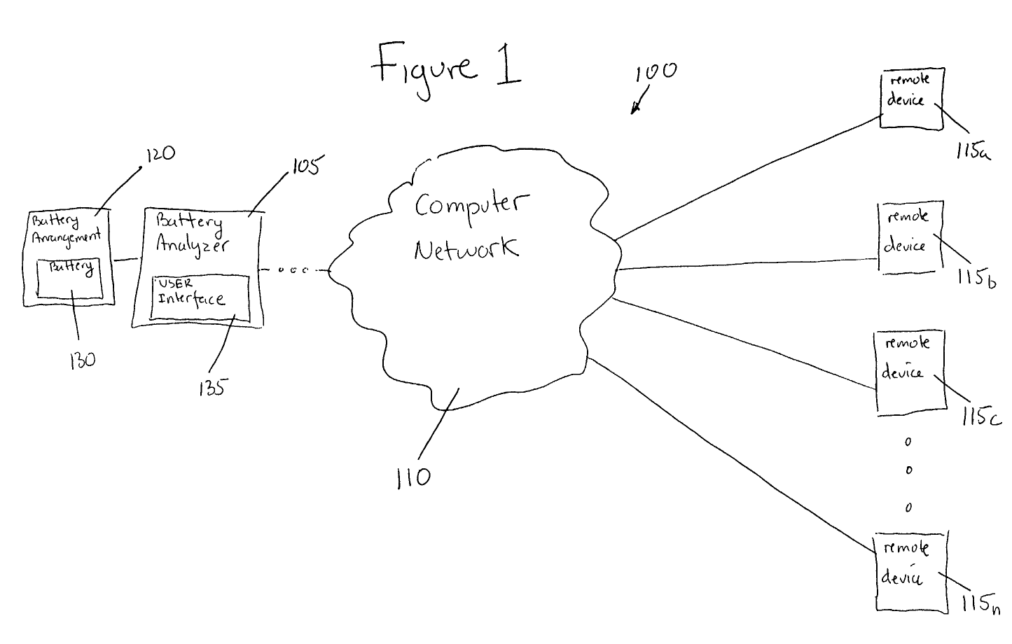

Referring now to FIG. 1, there is seen an exemplary battery analyzer system 100 according to the present invention. The battery analyzer system 100 includes a battery analyzer 105 having a user interface 135 and a battery arrangement 120 including at least one rechargeable battery 130. The battery arrangement 120 is electrically coupled to the battery analyzer 105. In the exemplary embodiment shown in FIG. 1, the battery analyzer 105 is communicatively coupled to at least one remote device 115a, 115b, 115c, . . . , 115n through a computer network 110.

The computer network 110 may include any conventional arrangement operable to communicatively couple the battery analyzer 105 to the remote device 115a, 115b, 115c, . . . , 115n, such as a dedicated point-to-point network, a token-ring network, a Wide Area Network (WAN), a Local Area Network (LAN), an intranet, an internet, and/or the Internet. Furthermore, each of the battery analyzer 105 and the remote devices 115a, 115b, 115c, . . . , 115n may be operable to communicatively couple to the computer network 110 by a hardwired connection (e.g., fiber optic cables and/or conductive cables) and/or by a wireless connection.

The battery analyzer 105 is operable to evaluate the battery 130 and to determine, for example, usage and performance information concerning the battery 130. The battery analyzer 105 may then communicate the usage and performance information, such as information indicating that the battery is not performing correctly, to one or more of the remote devices 115a, 115b, 115c, . . . , 115n via the computer network 110. The battery analyzer 105 may also communicate data related to technical support, which may include charging and discharging parameters used in configuring the power management controller. Technical support data could also include, for example, software update information, information to allow the remote location to change parameters, or automated software update if an outdated software version is detected.

The battery analyzer 105 is further operable to communicate user information, such as product order information, to one or more of the remote devices 115a, 115b, 115c, . . . , 115n in accordance with input data received from a user via the user interface 135.

Each of the remote devices 115a, 115b, 115c, . . . , 115n may include, for example, a respective centralized computer (not shown) operable to communicate information to the battery analyzer 105, such as marketing information, software updates for the battery analyzer 105 and/or the battery arrangement 120, user manuals, technical support data, product catalog information, battery specifications data, advertising information, and/or parameter information, such as battery charging and/or discharging parameters. Information received by the battery analyzer 105 may be displayed to a user of the battery analyzer 105 via the user interface 135. Further, the marketing and/or advertising information may be generated in accordance with the usage and performance information concerning the battery 130 received from the battery analyzer 105. In this manner, the battery analyzer 105 and/or the remote device 115a, 115b, 115c, . . . , 115n may inform the user, for example, if the battery 130 needs to be replaced or if the battery 130 is not operating properly.

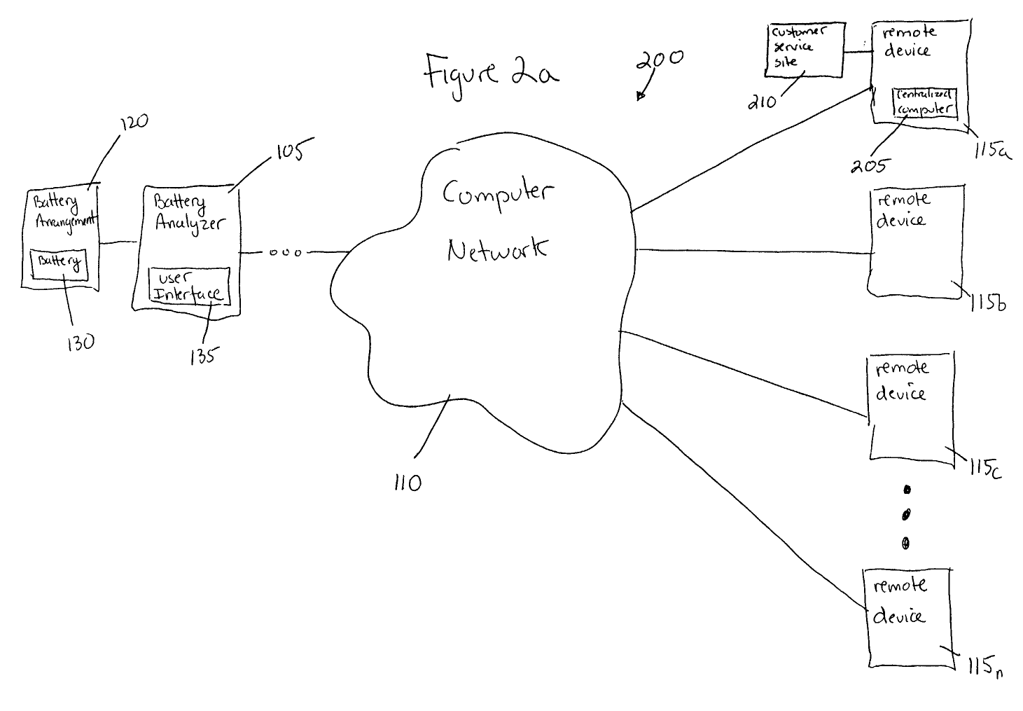

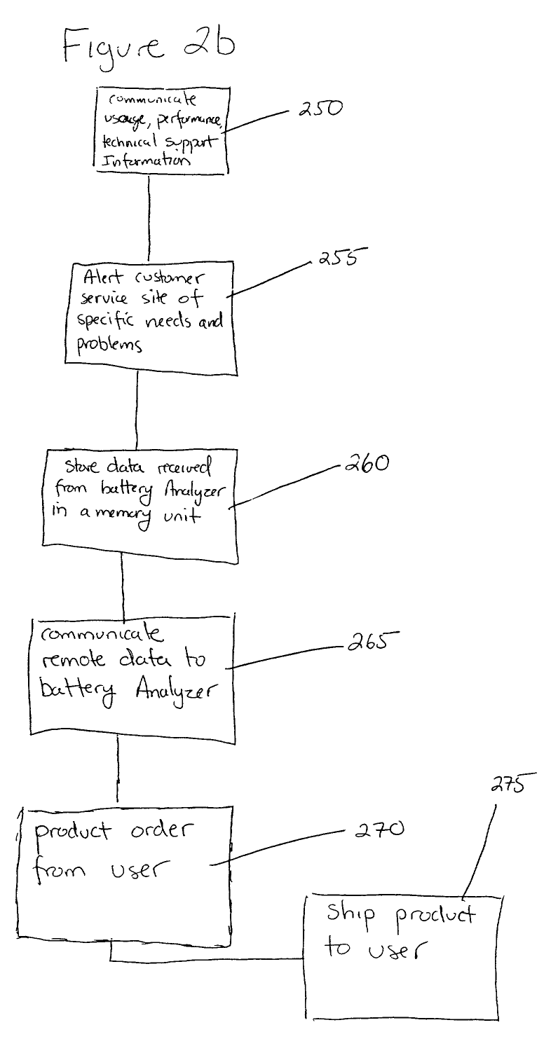

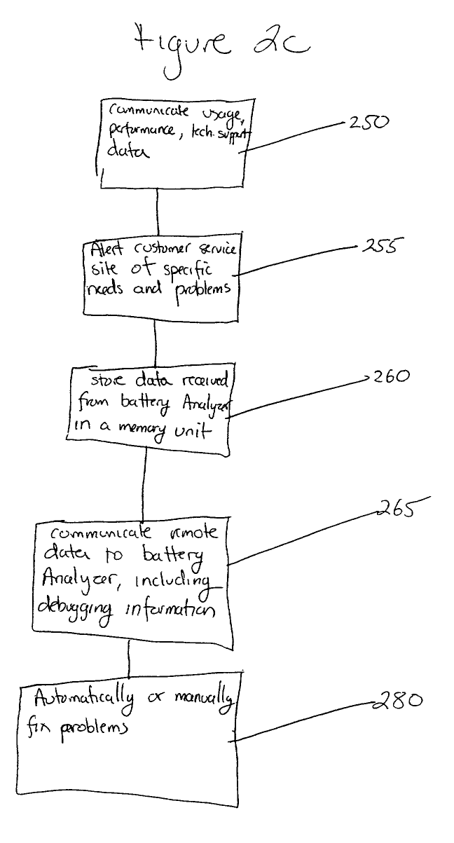

Referring now to FIG. 2a, there is seen another exemplary battery analyzer system 200, in which one of the remote devices 115a, 115b, 115c, . . . , 115n includes a centralized computer system 205 for collecting and distributing information to a customer service site 210. The customer service site 210 may be owned and controlled by any entity, for example, an individual, a manufacturer of the battery analyzer 105, and/or a retailer or wholesaler of the battery analyzer 105. The customer service site 210 may be located at the remote device 115a, 115b, 115c, . . . , 115n and may execute on the remote device 115a, 115b, 115c, . . . , 115n. Alternatively, the customer service site 210 may be separated from the remote device 115a, 115b, 115c, . . . , 115n and connected to the remote device 115a, 115b, 115c, . . . , 115n, for example, via a computer network. Moreover, the functionality of the customer service site 210 and/or the computer system 205 may be distributed across any number of processing units.

Referring now to FIG. 2b, there is seen a flow diagram of data communication between the battery analyzer 105 and the customer service site 210 illustrated in FIG. 2a. In step 250, the battery analyzer 105 communicates, for example, usage, performance, and/or technical support information of the battery arrangement 120 to the customer service site 210 via the computer network 110. This step may be initiated manually by the user, automatically by the battery analyzer 105 (e.g., at preselected intervals), and/or automatically by the customer service site 210 via the computer network 110. In step 255, the centralized computer system 205 may, for example, alert the customer service site 210 of specific needs and/or problems associated with the battery analyzer 105 and/or the battery arrangement 120 (e.g., usage trends, defective batteries, etc), based at least in part, for example, on the usage, performance, and/or technical support information received from the battery analyzer 105. In step 260 the usage, performance, and/or technical support information, as well as any other additional information transmitted by the battery analyzer 105, may be appropriately stored by the centralized computer system 205 in a memory unit (not shown) for subsequent retrieval, for example, to graph the usage and performance information and/or to perform numerical analysis on the usage and performance information. In step 265, the customer support site 210 may then communicate data to the battery analyzer 105 via the centralized computer system 205 and the computer network 110 in accordance with the usage, performance, and/or technical support information received from the battery analyzer 105.

In this regard, if the usage, performance, and technical support information indicate that the battery arrangement 120 is defective, the customer service site 210 may communicate, for example, a product catalog of batteries and/or accessories to the battery analyzer 105 to be displayed to the user via the user interface 135. In step 270, the user may optionally order, for example, replacement batteries and/or accessories from the product catalog of batteries and/or accessories via the user interface 135. The order may be communicated to the customer support site 210 via the computer network 110, for example. After receiving the order, the customer support site 210 may then cause the replacement batteries and/or accessories to be packaged and shipped to the user, as represented by step 275.

Alternatively or additionally, as seen in the flow diagram of FIG. 2c for example, if the usage, performance, and technical support information indicate that the battery analyzer 105 and/or the battery arrangement 120 is defective (e.g., if the battery 130 needs to be updated or modified, if the battery analyzer 105 is not working properly, etc.), the customer service site 210 may communicate, for example, debugging information to the battery analyzer 105 to be displayed to the user via the user interface 135. With the debugging information, the user may diagnose and fix various problems associated with the battery analyzer 105 and/or the battery arrangement 120, as represented by step 280. Alternatively, the customer service site 210 may debug the battery analyzer 105 and/or the battery arrangement 120 automatically and without intervention by the user. For example, if analyzer software stored in the battery analyzer 105 is defective, the customer service site 210 may communicate and automatically replace the analyzer software with replacement software via the computer network 110. Moreover, the customer service site 210 may communicate updated software and parameter information (including, for example, battery charging and/or discharging parameters) to the battery analyzer 105.

Furthermore, the centralized computer system 205 may directly control the battery analyzer 105 via the computer network 110. In this manner, the centralized computer system 205 may control, for example, the charging and/or discharging of the battery arrangement 120, the performance evaluation of the battery arrangement 120, the usage evaluation of the battery arrangement 120, the conditioning of the battery arrangement 120, and/or any other function of the battery analyzer 105.

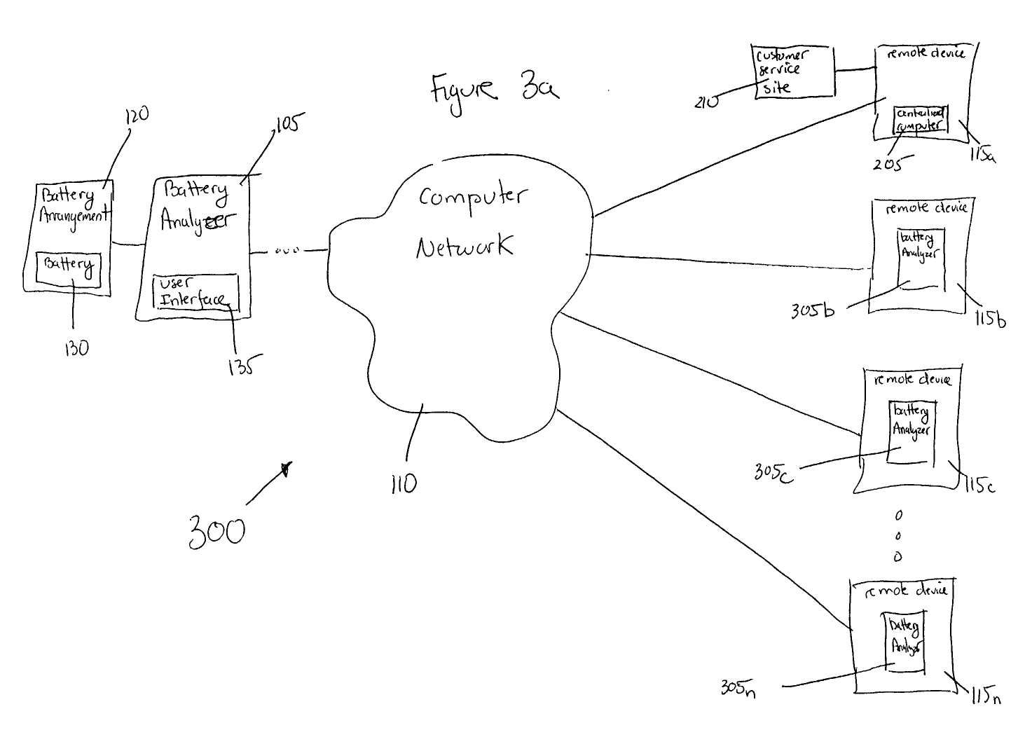

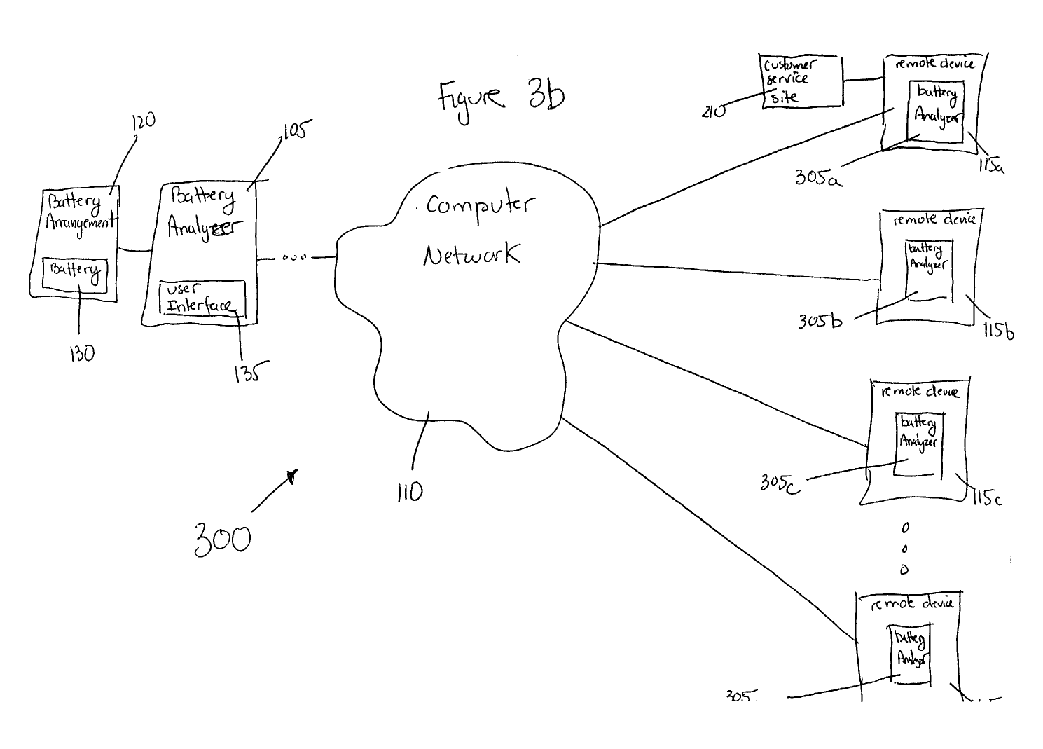

Referring now to FIG. 3a, there is seen another exemplary battery analyzer system 300, in which one of the remote devices 115a, 115b, 115c, . . . , 115n includes a centralized computer system 205 and a plurality of additional battery analyzers 305b, 305c, . . . , 305n. In this manner, it should be appreciated that information, such as usage, performance, and/or technical support information, may be transmitted between the battery analyzers 105 and/or 305b, 305c, . . . , 305n and/or between one or more battery analyzers 105 and/or 305b, 305c, . . . , 305n and the centralized computer system 205. It should also be appreciated that the centralized computer system 205 may communicate marketing information, software updates for the battery analyzer 105, user manuals, technical support data, product catalog information, battery specifications data, charging/discharging parameters and/or advertising information selectively to a single one of battery analyzers 105 and 305b, 305c, . . . , 305n, a group of two or more of battery analyzers 105 and 305b, 305c, . . . , 305n, or to all of battery analyzers 105 and 305b, 305c, . . . , 305n. For this purpose, each of the battery analyzers 105 and 305b, 305c, . . . , 305n and the centralized computer system 205 may be assigned a unique, respective network address for identification over the computer network 110.

FIG. 3b illustrates the exemplary battery analyzer system 300 of the FIG. 3a, in which each of the remote devices 115a, 115b, 115c, . . . , 115n includes at least one respective battery analyzer 305a, 305b, 305c, . . . , 305n. In this manner, it should be appreciated that any one of the battery analyzers 105 and 305a, 305b, 305c, . . . , 305n may perform functions similar to those described above with respect to the centralized computer system 205. For example, any one of the battery analyzers 105 and 305a, 305b, 305c, . . . , 305n may communicate information, such as user manuals, technical support data, product catalog information, battery specifications data, battery charging/discharging parameters and/or advertising information. Further, any one of the battery analyzers 105 and 305a, 305b, 305c, . . . , 305n may troubleshoot and/or directly control one or more of the other battery analyzers 105 and 305a, 305b, 305c, . . . , 305n.

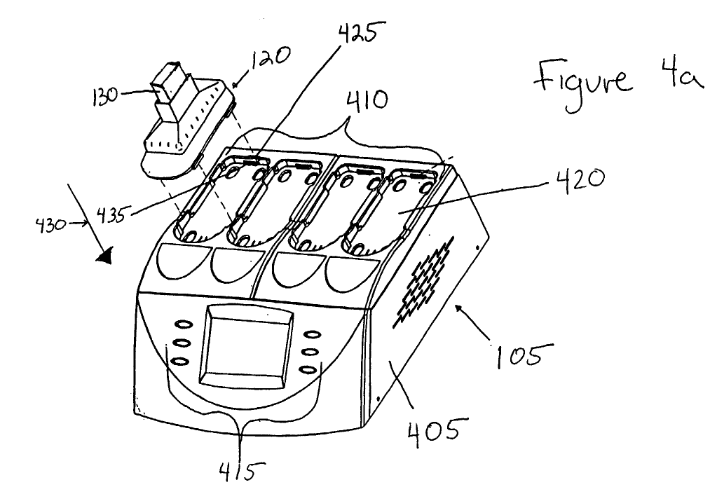

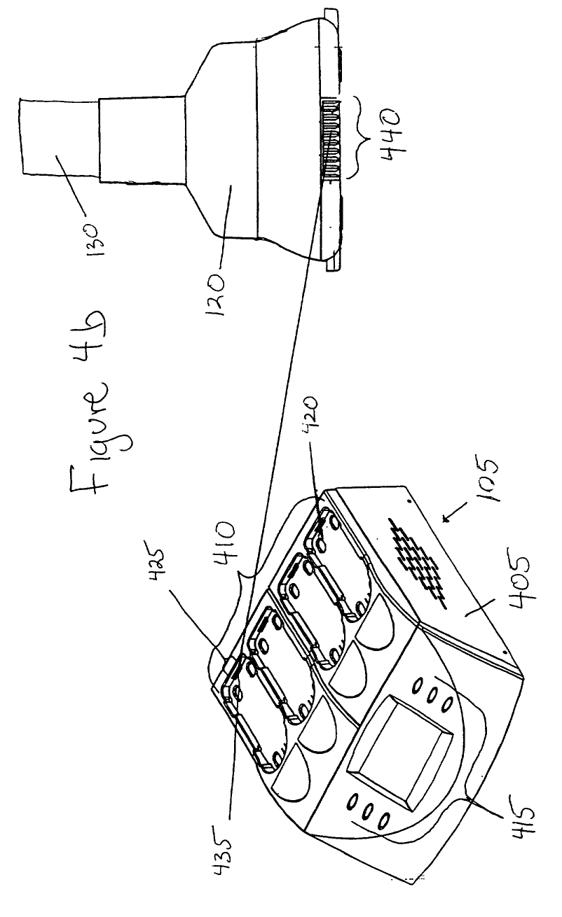

Referring now to FIG. 4a, there is seen an illustration of the battery analyzer 105 of FIGS. 1, 2a, 3a, and 3b. The battery analyzer 105 is electrically connected to and receives power from an external power source (not shown). The battery analyzer 105 includes a base unit 405 having a user interface 415 and a battery interface arrangement 410 including at least one port 420.

Each of the ports 420 is suitably configured to releaseably and electrically couple to a respective battery arrangement 120. For this purpose, each of the ports 420 of the battery analyzer 105 includes an analyzer connector 425 having a plurality of conductive contacts 435, which electrically couple to the battery arrangement 120 when the battery arrangement 120 is lowered into one of the ports 420. At least two of the conductive contacts 435 are provided to charge and/or discharge the battery 130 of the battery arrangement 120.

The battery arrangement 120 is lowered into one of the ports 420 in a first direction 430, whereby the conductive contacts 435 of the battery analyzer 105 electrically couple to the battery arrangement 120.

The user interface 415 of the battery analyzer 105 may communicate, for example, status information to the user concerning one or more of the ports 420. For example, the user interface 415 may indicate whether one or more of the ports 420 are receiving power from the external power source and/or whether the battery arrangement 120 is charging in one of the ports 420. The user interface 415 may also indicate the amount of power (i.e., charge) that is maintained by a battery 130 of the battery arrangement 120.

Referring now to FIG. 4b, there is seen an illustration showing the electrical connectivity between the battery arrangement 120 of FIG. 4a and the battery analyzer 105. As shown in FIG. 4b, the conductive contacts 435 of the battery analyzer 105 electrically contact a plurality of conductive contacts 440 of the battery arrangement 120.

Referring now to FIGS. 4a and 4b, power is received from the external power source (not shown) and provided to the analyzer connector 425 of one or more of the ports 420, including the port 420 to which the battery arrangement 120 is coupled, thereby providing the power to the battery 130 of the battery arrangement 120.

In addition to facilitating the charging and/or discharging of the battery 130 of the battery arrangement 120, at least some of the conductive contacts 435 of the battery analyzer 105 may be used, for example, to facilitate data communication between the battery analyzer 105 and the battery arrangement 120. For example, in lieu of the battery analyzer 105 charging and/or discharging the battery 130, the battery analyzer 105 may instruct the battery arrangement 120 to charge and/or discharge the battery 130, if the battery arrangement 120 includes an arrangement, for example, a battery adapter, capable of charging and/or discharging the battery 130.

The battery arrangement 120 may include a battery 130 and/or a battery adapter having a battery 130, as described in U.S. Patent Application attorney docket No. 02520/49401 entitled “Battery Adapter,” filed concurrently herewith and expressly incorporated herein by reference.

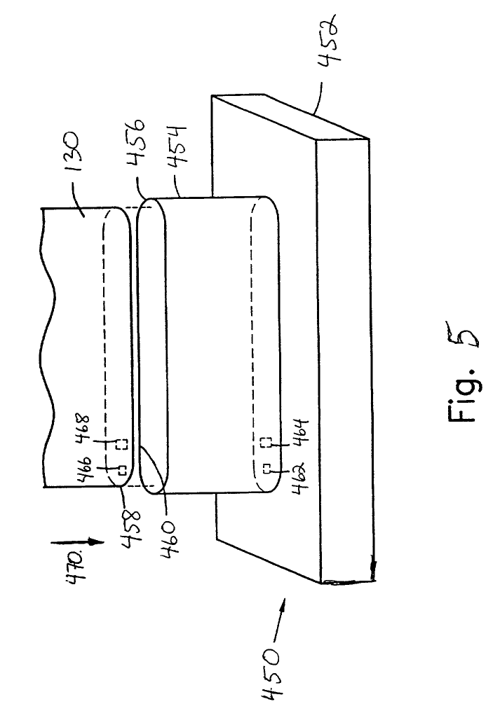

FIG. 5 illustrates an exemplary battery adapter 450. Battery adapter 450 includes a base unit 452, battery holder 454, and a circuit arrangement (not shown). The battery holder 454 is connected to base unit 452 and has a receptacle portion 456 for receiving the battery 130. The receptacle portion 456 of the battery holder 454 may be pre-configured to receive various types of batteries, such as nickel cadmium batteries, nickel metal-hydride batteries, lithium batteries, etc.

As shown in FIG. 5, the external surface 458 of the battery 130 has a smaller geometry than the geometry of an external surface 460 of the battery holder 454. Thus, the battery 130 may be inserted into the receptacle portion 456, for charging and/or discharging.

The battery adapter 450 includes a first adapter contact 462 and a second adapter contact 464. The first and second adapter contacts 462, 464 may be provided, for example, in the base unit 452, in the battery holder 454 or separately therebetween. The first adapter contact 462 is provided for conductively connecting to a first battery contact 466 of the battery 130, and the second adapter contact 464 is provided for conductively connecting to a second battery contact 468 of the battery 130. As the battery 130 is lowered into the battery holder 454 in a second direction 470, the first and second adapter contacts 462, 464 of the battery adapter 450 electrically connect to the respective first and second battery contacts 466, 468 of the battery 130.

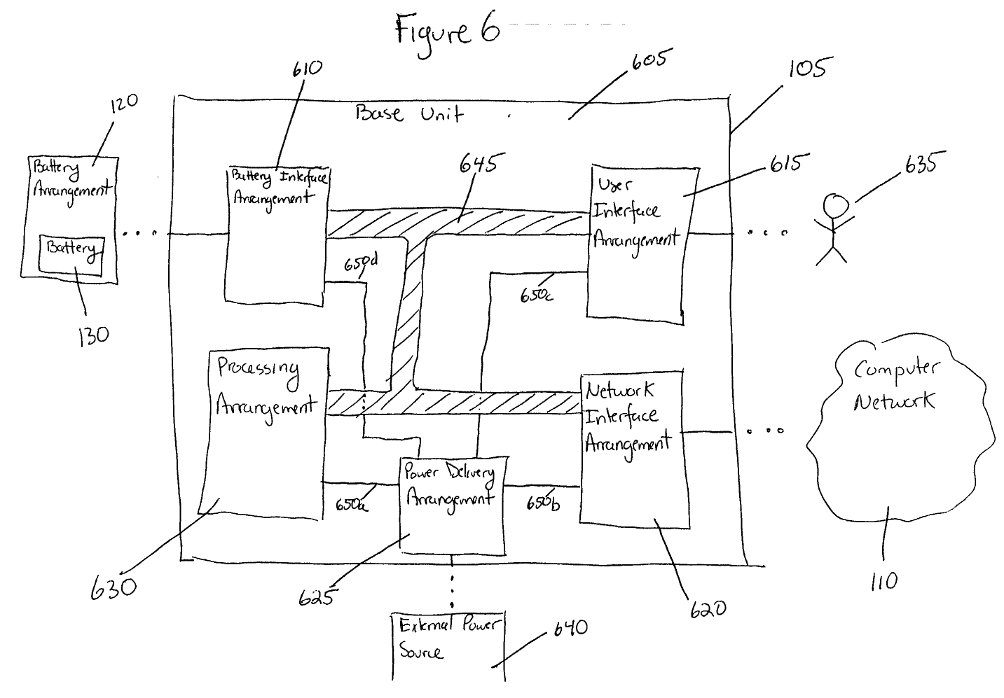

Referring now to FIG. 6, there is seen a block diagram of the exemplary battery analyzer 105 illustrated in FIGS. 1, 2a, 3a, and 3b. Battery analyzer 105 includes a base unit 605. The base unit 605 has a battery interface arrangement 610 configured to electrically couple to one or more battery arrangements 120, a user interface arrangement 615 configured to communicate user information to a user 635 and for receiving user input data from the user 635, a network interface arrangement 620 configured to communicatively couple to the computer network 110, a power delivery arrangement 625 configured to receive power from an external power source 640 and providing said power to the battery analyzer 105 via internal power connections 650a, 650b, 650c, 650d, and a processing arrangement 630. The battery interface arrangement 610, the user interface arrangement 615, the network interface arrangement 620, and the processing arrangement 630 are electrically and communicatively coupled to one another via data bus 645.

Network interface arrangement 620 includes circuitry operable to communicatively couple to the computer network 110. For example, network interface arrangement 620 may include circuitry operable to communicatively couple to an ethernet, a token-ring network, a dedicated point-to-point network, a WAN, a LAN, an intranet, an internet, and/or the Internet. In this regard, the network interface arrangement 420 of the battery analyzer 105 may be assigned a unique network address, which uniquely identifies the battery analyzer 105 over the computer network 110, with respect to the remote devices 115a, 115b, 115c, . . . , 115n.

It should be appreciated that each of the remote devices 115a, 115b, 115c, . . . , 115n includes network interface circuitry and a unique network address similar to those of the network interface arrangement 620 of the battery analyzer 105. This permits the battery analyzer 105 to selectively communicate with one or any number of the remote devices 115a, 115b, 115c, . . . , 115n via the computer network 110.

The network interface arrangement 620 is operable to receive data from one or more of the remote devices 115a, 115b, 115c, . . . , 115n via the computer network 110 and to provide the data to the processing arrangement 630 via the data bus 645. The data may include, for example, marketing information, software updates for the battery analyzer 105 and/or for the battery arrangement 120, user manuals, technical support data, product catalog information, battery specifications data, advertising information, and/or parameter data including, for example, charging and/or discharging parameters for a battery. The network interface arrangement 620 is also operable to receive data from the processing arrangement 630 via the data bus 645 and to communicate the data to the one or more of the remote devices 115a, 115b, 115c, . . . , 115n via the computer network 110. The data may include, for example, usage, performance, and/or technical support information concerning the battery 130 of the battery arrangement 120 and/or user information, such as battery and accessory orders.

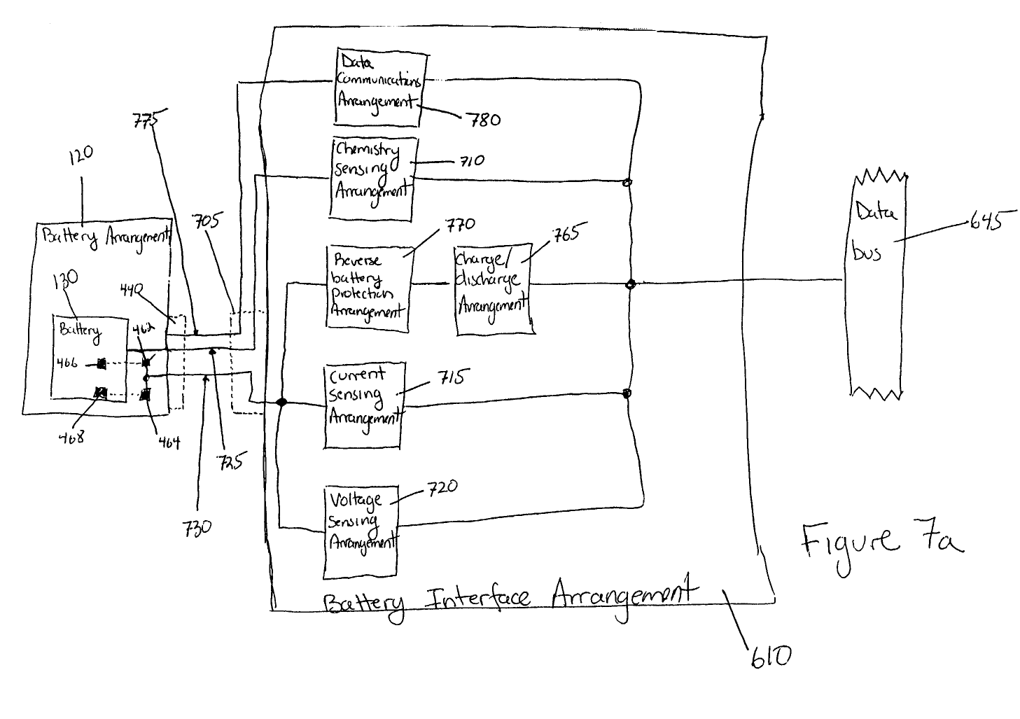

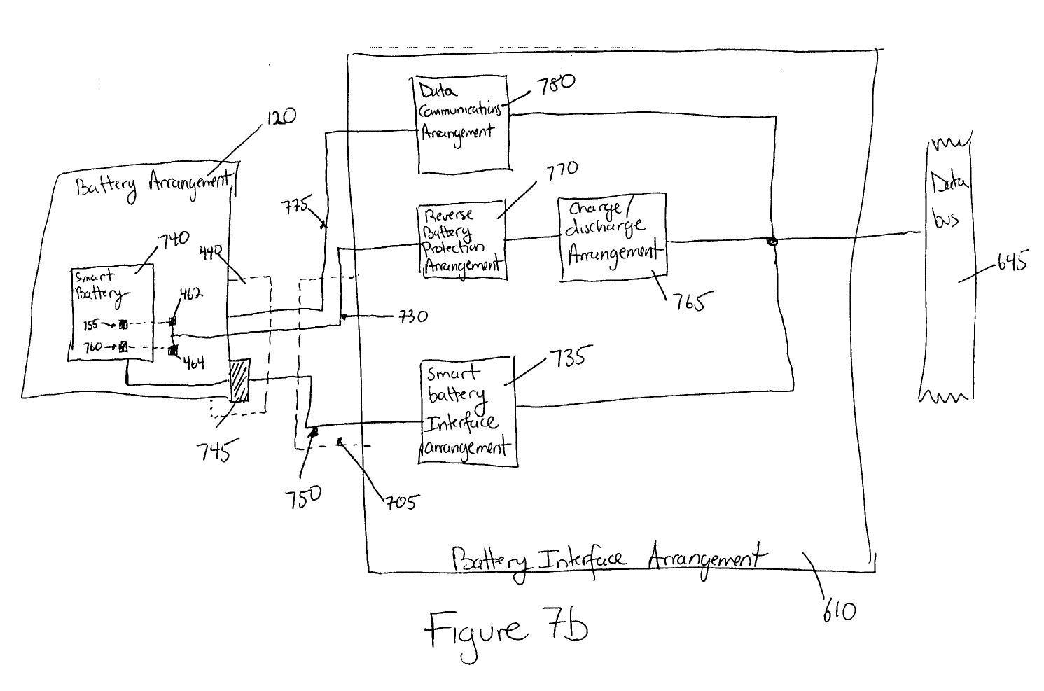

Referring now to FIG. 7a, there is seen further detail of the exemplary battery interface arrangement 610 of FIG. 6 for electrically connecting to at least one battery arrangement 120 via a respective analyzer connector 705. The analyzer connector 705 includes a plurality of conductive contacts operable to electrically couple to the plurality of conductive contacts 440 of the battery arrangement 120. In this exemplary embodiment, the conductive contacts of the analyzer connector 705 include battery interface contacts 730, data interface contacts 775, and a tri-state data contact 725.

It should be appreciated that, although FIG. 7a illustrates a single battery arrangement 120, the battery interface arrangement 610 may be operable to electrically couple to a plurality of battery arrangements, each of which includes a respective battery, which may be of a different type (e.g., a nickel cadmium battery, a nickel metal-hydride battery, a lithium ion battery, etc.).

Battery interface arrangement 610 includes a data communications arrangement 780, a charge/discharge arrangement 765, a reverse-battery protection arrangement 770, a current sensing arrangement 715, a voltage sensing arrangement 720, and a chemistry sensing arrangement 710. Each of the reverse-battery protection arrangement 770, the current sensing arrangement 715, and the voltage sensing arrangement 720 is electrically coupled to the first and second adapter contacts 462, 464 of the battery arrangement 120 via the battery interface contacts 730 of the analyzer connector 705. As described above, the first and second adapter contacts 462, 464 electrically contact the first and second battery contacts 466, 468 when the battery 130 is received by the battery arrangement 120. The data communications arrangement 780 is electrically and communicatively coupled to the battery arrangement 120 via the data interface contacts 775. The chemistry sensing arrangement 710 is electrically and communicatively coupled to the battery arrangement 120 via the tri-state logic data contact 725. The charge/discharge arrangement 765 is electrically coupled to the reverse-battery protection arrangement 770. Additionally, each of the data communications arrangement 780, the charge/discharge arrangement 765, the current sensing arrangement 715, the voltage sensing arrangement 720, and the chemistry sensing arrangement 710 is electrically and communicatively coupled to the data bus 645.

The data communications arrangement 780 includes circuitry operable to electrically and communicatively couple to the battery arrangement 120. The data communications arrangement 780 permits data to be communicated to the battery arrangement 120 by the processing arrangement 630 of the battery analyzer 105 and/or permits data to be communicated to the processing arrangement 630 of the battery analyzer 105 from the battery arrangement 120. For example, if the battery arrangement 120 includes a battery adapter 450 as described above, the processing arrangement 630 may, for example, reconfigure the battery adapter 450 by communicating updated program code to be executed by a micro-computer situated in the battery adapter 450. The processing arrangement 630 may also communicate parameter data relating to, for example, charging and/or discharging of a battery 130 of the battery arrangement 120. For this purpose, the processing arrangement 630 communicates the updated program code and/or the parameter data to the data communications arrangement 780 via the data bus 645, and the data communications arrangement 780 then communicates the updated program code to the battery arrangement 120 via the data interface contacts 775 of the analyzer connector 705. The battery adapter 450 may also, for example, communicate usage and performance information concerning the battery 130 to the processing arrangement 630. For this purpose, the battery adapter 450 communicates the usage and performance information to the data communications arrangement 780 via the data interface contacts 775, and the data communications arrangement 780 then communicates the usage and performance information to the processing arrangement 630 via the data bus 645.

The charge/discharge arrangement 765 includes circuitry operable to charge and/or discharge the battery 130 of the battery arrangement 120 via the battery interface contacts 730 of the analyzer connector 705. The charge/discharge arrangement 765 is controlled by the processing arrangement 630 via the data bus 645 as more fully described below.

To initiate an efficient charging of the battery 130, the charge/discharge arrangement 765 may employ a combination of constant voltage control (CV) and constant current control (CV), in accordance with the chemistry of battery 130, such as, for example, nickel cadmium, nickel metal-hydride, lithium, etc. Each chemistry may utilize a unique combination of CV and CC control, that is, a unique charge profile. In CV control, the charge/discharge arrangement 765 provides a constant voltage across the first and second battery contacts 466, 468 of the battery 130. The constant voltage applied depends on a desired final charging voltage of the battery 130. For example, if a user desires to charge battery 130 to 5 volts, CV control applies a constant voltage of 5 volts across the first and second battery contacts 466, 468 of the battery 130. If battery 130 is a fully uncharged battery, the constant voltage applied causes a large initial current to flow through (i.e., spike through) the first and second battery contacts 466, 468. To prevent the current from “spiking” during an initial charge, CC control may be employed to effectively limit the maximum amount of current fed to the charging battery 130. As the battery 130 charges, the voltage of the battery 130 approaches the constant voltage applied by the charge/discharge arrangement 765, thereby causing the current flowing through the first and second battery contacts 466, 468 of the battery 130 to decrease. Once the battery 130 reaches the desired final charging voltage, for example, 5 volts, the charge/discharge arrangement 765 ceases charging the battery 130.

To initiate an efficient discharge of the battery 130, the charge/discharge arrangement 765 short-circuits the battery contacts 466, 468 of the battery 130 to ground through a low-resistance conductive path. The lower the resistance of the path to ground, the faster the battery 130 will discharge. However, the faster the battery 130 discharges, the faster the battery 130 generates energy and heat. To prevent potentially damaging effects of the energy and heat, the charge/discharge arrangement 765 may include a large heat sink and/or fan (not shown) to dissipate the energy and heat generated by the discharging battery 130.

The reverse battery protection arrangement 770 prevents the battery 130 from being damaged, such as if the battery 130 is improperly inserted into the battery arrangement 120 or if the battery arrangement 120 is improperly inserted into the battery analyzer 105 (this may generate a short circuit, an overload, etc.). The reverse battery protection arrangement 770 may also prevent any such damage to the battery analyzer 105.

The current sensing arrangement 715 and the voltage sensing arrangement 720 include circuitry operable for detecting the current and voltage across the first and second battery contacts 466, 468 of the battery 130, respectively. The current sensing arrangement 715 and the voltage sensing arrangement 720 communicate the sensed voltage and sensed current to the processing arrangement 630 via the data bus 645.

The chemistry sensing arrangement 710 includes circuitry operable to detect the chemistry of the battery 130, such as, for example, a nickel cadmium battery, a nickel metal-hydride battery, a lithium battery, etc. The chemistry sensing arrangement 710 may include electrical circuitry operable to connect to the tri-state logic data line 725, which may be provided by battery arrangement 120. Tri-state logic data line 725 may include three discrete logical states, e.g., “high,” “low,” and “float”. Each state may be used to communicate a different chemistry. For example, a “high” logic level may indicate that battery arrangement 120 includes a nickel metal-hydride battery, a “low” may indicate that battery arrangement 120 includes a nickel cadmium battery, and a “float” may indicate that battery arrangement 120 includes a lithium battery. The chemistry detect arrangement 710 communicates the sensed chemistry of the battery 130 to the processing arrangement 630 for use in generating a desired charge profile and/or a performance sequence, as described more fully below.

As described above, the current, voltage, and chemistry of the battery 130 are sensed and communicated to the processing arrangement 630 by the current sensing arrangement 715, the voltage sensing arrangement 720, and the chemistry sensing arrangement 710 of the battery interface arrangement 610, respectively. However, certain types of batteries, for example, “smart” batteries, include “smart” circuitry, capable of communicating digital information concerning the battery, such as current, voltage, and chemistry. This circuitry may include an internal micro-computer and a digital interface for communicating information with an external device, such as, battery analyzer 105.

To communicate information between the “smart” battery and the battery analyzer 105, any data communications protocol and/or specification may be used. For example, the battery analyzer 105 may use the System Management Bus (SMBus) specification v.2.0 to communicate data back and forth between the “smart” battery. The SMBus specification defines a two-wire interface through which various components situated in different systems may communicate data between each other. With a smart-battery communications protocol, such as SMBus, a device may provide manufacturer information, model part information, error information, and status information, as well as receive control parameters and configuration information.

Referring now to FIG. 7b, there is seen further detail of a variant of the battery interface arrangement 610 of FIG. 6 operable to communicatively couple to a smart battery 670. In addition to or in lieu of the current sensing arrangement 715, the voltage sensing arrangement 720, and the chemistry sensing arrangement 710, for detecting current, voltage, and chemistry of the battery 130, respectively, the battery interface arrangement 610 may include a smart-battery interface 735 electrically and communicatively coupled to the data bus 645. As shown in FIG. 7b, the smart-battery interface 735 includes circuitry operable to electrically and communicatively couple to a battery arrangement 120 that includes a special data port 745 for communicating information concerning a smart-battery 740 to an external device, such as the smart-battery interface 735 of the battery interface arrangement 610. The special data port 745 includes a plurality of data lines 750 for communicating information, such as the current flowing through the smart-battery 740, the voltage across the first and second smart battery contacts 755, 760 of the smart battery 740, the chemistry of the smart-battery 740, a serial number associated with the smart battery 740, a model number associated with the smart-battery 740, etc. The smart-battery interface 735 then communicates the received information, such as the current, voltage, and chemistry of the smart battery 740, to the processing arrangement 630 via the data bus 645 for further processing as described below.

Alternatively, it should be appreciated that the battery arrangement 120 may include current, voltage, and sensing arrangements and/or a smart-battery interface similar to those of the battery analyzer 105. In this regard, the battery arrangement 120, for example, the battery adapter 450, may detect the current, voltage, and chemistry of the battery 130 and then provide the current, voltage, and chemistry of the battery 130 to the battery analyzer 105 via the data communications arrangement 780 of the battery interface arrangement 610. In this manner, the processing arrangement 30 may receive the current, voltage, and chemistry information without the need for the current sensing arrangement 715, the voltage sensing arrangement 720, the chemistry sensing arrangement 710 or the smart-battery interface 735.

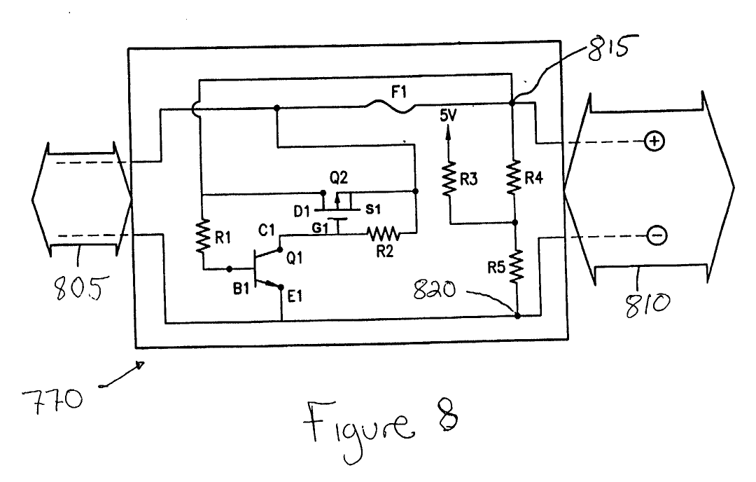

Referring now to FIG. 8, there is seen further detail of the reverse-battery protection arrangement 770 illustrated in FIGS. 7a and 7b. The reverse battery protection arrangement 770 prevents the battery 130 of the battery arrangement 120 from being damaged and may also prevent any such damage to the battery analyzer 105. The reverse battery protection arrangement 770 is electrically connected to the battery charge/discharge arrangement 765 via a first connection arrangement 805. The reverse battery protection arrangement 770 also communicates with the battery arrangement 120 via a second connection arrangement 810. As illustrated in FIG. 8, the reverse battery protection arrangement 770 may include a first switch Q1, a second switch Q2, a first resistor R1, a second resistor R2 and a fuse F1. In an alternative embodiment, fuse F1 is not used, as the reverse battery protection features of the reverse battery protection arrangement 770 may provide sufficient protection without it.

The first battery contact 466 of the battery 130 is conductively coupled to, e.g., a first terminal 815 of the reverse battery protection arrangement 770 via one of battery interface contacts 730. The second battery contact 468 of the battery 130 is conductively coupled to a second terminal 820 of the reverse battery protection arrangement 770.

In operation, when the battery 130 is properly received by the battery arrangement 120 and when the battery arrangement 120 is properly coupled to the battery analyzer 105 (e.g., the first battery contact 466 is electrically coupled to the first terminal 815, and the second battery contact 468 is electrically coupled to the second terminal 820), the first switch Q1 is turned on because the voltage at a terminal B1 of the first switch Q1 is higher than the voltage at a terminal E1. By turning on the first switch Q1, a terminal G1 enables the second switch Q2 (i.e., switches on the second switch Q2), and thus the current flows between a terminal D1 and a terminal S1 of the second switch Q2.

When the battery 130 is improperly received by the battery arrangement 120 or when the battery arrangement 120 is improperly coupled to the battery analyzer (e.g., the first battery contact 466 is electrically coupled to the second terminal 820, and the second battery contact 468 is electrically coupled to the first terminal 815), the first switch Q1 is turned off because the voltage at the terminal B1 of the first switch Q1 is lower than the voltage at the terminal E1. Because the first switch Q1 is turned off, the second switch Q2 is also switched off, and thus the current is prevented from flowing between the terminal D1 and the terminal S1 of the second switch Q2.

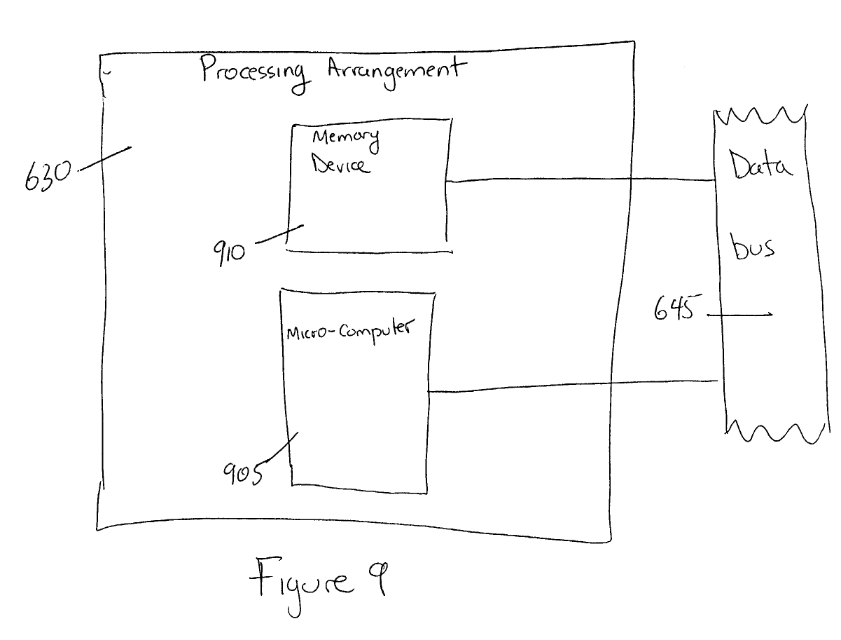

Referring now to FIG. 9, there is seen further detail of the exemplary processing arrangement 630 illustrated in FIG. 6. The processing arrangement 630 may include electrical circuitry situated, for example, on a single printed circuit board or, alternatively, may be situated on a plurality of circuit boards. The processing arrangement 630 includes circuitry operable to control, for example, the charging and/or discharging of the battery 130 via the charge/discharge arrangement 765 of the battery interface arrangement 610. FIG. 9 shows the processing arrangement 630 including a micro-computer 905 and a memory device 910, each of which is electrically and communicatively coupled to the data bus 645. The memory device 910 may include any readable/writable memory device, such as, a Random Access Memory (RAM), FLASH, EEPROM, EPROM, CD-drive, mini-disk, floppy disk, hard disk, etc. The memory device 910 may store suitably configured program code for execution on the micro-computer 905. The program code stored on the memory device 910 may include the Linux operating system. However, the processing arrangement 630 is configured to be flexible and to accommodate different operating systems if necessary.

The memory device 910 is operable to store other information, such as information relating to a charging status of the battery 130, information relating to a discharging status of the battery 130, information relating to a performance of the battery 130, information relating to a usage of the battery 130, information relating to technical support concerning the battery 130, etc.

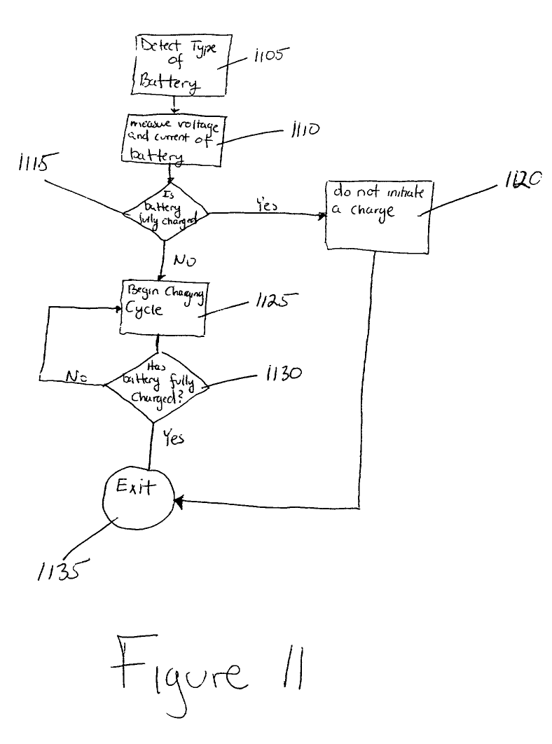

Referring now to FIG. 11, there is seen a control sequence executed by the processing arrangement 630 for charging a battery 130. In step 1105, the processing arrangement 630 detects the type of battery 130 connected to the battery arrangement 120. For this purpose, the processing arrangement 630 receives the sensed chemistry from the chemistry sensing arrangement 710. Alternatively, as described above, the processing arrangement 630 may receive the sensed chemistry from a smart-battery interface 735 if battery 130 is a smart-battery and/or from the battery arrangement 120 via the data communications arrangement 780. In step 1110, the processing arrangement 630 monitors the voltage across the first and second battery contacts 466, 468 of the battery 130 via the voltage sensing arrangement 720 and/or monitors the current flowing through the first and second battery contacts 466, 468 of the battery 130 via the current sensing arrangement 715. As described above, the voltage and current sensing arrangements 720, 715 provide the sensed voltage and current, respectively, to the processing arrangement 630 via the data bus 645. In step 1115, the processing arrangement 630 compares the sensed voltage and sensed current of the battery 130 to a predetermined voltage and/or current associated with a fully charged battery. The voltage and/or current associated with a fully charged battery may be received from the user 635 via the user interface arrangement 615, from one or more remote devices 115a, 115b, 115c, . . . , 115n via the computer network, and/or from the battery arrangement 120 via the data communications arrangement 780. If the processing arrangement 630 determines that the battery 130 is fully charged, the processing arrangement will not initiate a charge of the battery 130 (since overcharging may damage the battery 130), as represented by step 1120. However, if the sensed voltage and/or current is below the predetermined voltage and/or current associated with a fully charged battery, then battery 130 is not fully charged and, as such, the processing arrangement 630 begins a charging cycle in step 1125. For this purpose, the processing arrangement 630 instructs the charge/discharge arrangement 765 to initiate a charge of the battery 130, as more fully described above. During the charge cycle, the processing arrangement 630 continues to monitor the voltage and the current of battery 130 in step 1130. If the sensed voltage and/or current is below the predetermined voltage and/or current associated with a fully charged battery, the processing arrangement 630 continues to charge the battery 130 in step 1125. Once the sensed voltage and/or current reaches the predetermined voltage and/or current associated with a fully charged battery, the processing arrangement 630 ceases charging the battery 130 and exits the charge routine in step 1135.

As described above, the current sensing arrangement 715, the voltage sensing arrangement 720, and the chemistry sensing arrangement 710 provide the sensed current, sensed voltage, and sensed chemistry of the battery 130 to the processing arrangement 630 via the data bus 645. The processing arrangement 630 may use the sensed current, the sensed voltage, and the sensed chemistry of the battery 130 to influence the charge profile of the battery 130. For example, if a fully discharged battery 130 is initially received by the battery arrangement, for example, the battery adapter 450, the processing arrangement 630 may initially provide a CV control voltage that exceeds the desired final charging voltage. For example, if the user 635 desires a final charging voltage of 5 volts, the processing arrangement 630 may initially provide a CV control voltage of 8 volts. Providing CV control in this manner causes the battery 130 to charge faster. As the voltage across the first and second battery contacts 466, 468 of the battery 130 approaches the desired final charging voltage, the processing arrangement 630 may gradually reduce the CV control voltage to 5 volts, thereby preventing the battery 130 from charging to a voltage that exceeds the desired final charging voltage.

The processing arrangement 630 may also influence the charge profile in accordance with the current flowing through the first and second battery contacts 466, 468 of the battery 130. For example, as the voltage across the first and second battery contacts 466, 468 approaches the desired final charging voltage, the current flowing through the first and second battery contacts 466, 468 decreases. During an initial charge of a fully discharged battery, the current flowing through the first and second battery contacts 466, 468 will be relatively high. The processing arrangement 630 may, for example, raise the initial CV control voltage above the desired final charging voltage of the battery 130, while the current flowing through the first and second battery contacts 466, 468 is relatively high, and then gradually reduce the CV control voltage as the current flowing through the first and second battery contacts 466, 468 decreases.

The sensed current, sensed voltage, sensed chemistry, and a sensed temperature (e.g., from a thermistor) of the battery 130 may also be used by the processing arrangement 630 to initiate a condition cycle of the battery 130. A condition cycle may be required to compensate for battery memory, which causes some rechargeable batteries to hold less charge during a charging cycle if they are not discharged completely before being charged, or if a poorly designed battery charger continues to charge a battery after the battery is fully charged.

Two types of batteries that suffer from the effects of battery memory are Ni—Cd batteries and nickel metal hydride batteries, although nickel metal hydride batteries do not suffer from the effects of battery memory to the same extent as do Ni—Cd batteries.

Lithium ion batteries and lead acid batteries, for example, automobile batteries, are generally very reliable. Neither of these types of batteries suffer substantially from the effects of battery memory.

The negative effects of battery memory may be reduced by successive cycles of discharging and recharging the battery 130, for example, discharging and recharging the battery 130 three times. To determine battery memory, the battery analyzer 105 may monitor the temperature of the battery 130 sometime after the battery analyzer 105 fully charges the battery 130. The temperature of the battery may be sensed by a thermistor situated in the battery arrangement 120 and then provided to the battery analyzer 105 via the data communications arrangement 780. Then, based at least in part on the sensed current, sensed voltage, sensed chemistry, and/or sensed temperature of the battery 130, the processing arrangement 630 of the battery analyzer 105 may initiate a condition cycle via the charge/discharge arrangement 765.

It should be appreciated that, instead of the processing arrangement 630 initiating the condition cycle, the processing arrangement 630 may instruct the battery arrangement 120 to initiate the condition cycle if the battery arrangement 120 has the capability to perform a condition cycle. For this purpose, the processing arrangement may instruct the battery arrangement 120 to perform the condition cycle via the data communications arrangement 780.

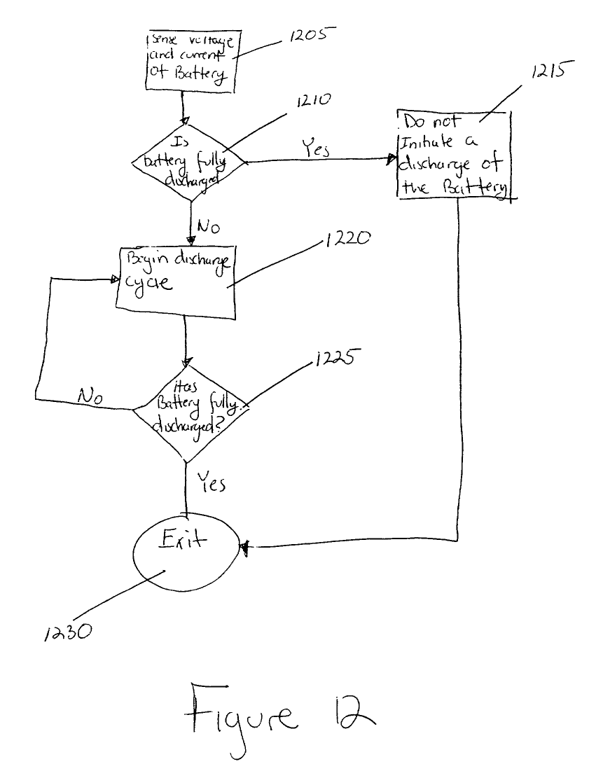

Referring now to FIG. 12, there is seen a control sequence executed by the processing arrangement 630 for discharging a battery 130. In step 1205, the processing arrangement 630 monitors the voltage across the first and second battery contacts 466, 468 of the battery 130 via the voltage sensing arrangement 720 and/or monitors the current flowing through the first and second battery contacts 466, 468 of the battery 130 via the current sensing arrangement 715. As described above, the voltage and current sensing arrangements 720, 715 provide the sensed voltage and current, respectively, to the processing arrangement 630 via the data bus 645. In step 1210, the processing arrangement 630 compares the sensed voltage and sensed current of the battery 130 to a predetermined voltage and/or current associated with a fully discharged battery. The voltage and/or current associated with a fully discharged battery may be received from the user 635 via the user interface arrangement 615, from one or more remote devices 115a, 115b, 115c, . . . , 115n via the computer network, and/or from the battery arrangement 120 via the data communications arrangement 780. If the processing arrangement 630 determines that the battery 130 is fully discharged, i.e., the sensed voltage and/or sensed current is at or below the predetermined voltage and/or current associated with a fully discharged battery, the processing arrangement 630 will not initiate a discharge of the battery 130 (since full depletion of the battery charge may damage the battery 130), as represented by step 1215. However, if the sensed voltage and/or current is above the predetermined voltage and/or current associated with a fully discharged battery, then battery 130 is not fully discharged and, as such, the processing arrangement 630 begins a discharging cycle in step 1220. For this purpose, the processing arrangement 630 instructs the charge/discharge arrangement 765 to initiate a discharge of the battery 130, as more fully described above. During the discharge cycle, the processing arrangement 630 continues to monitor the voltage and the current of battery 130 in step 1225. If the sensed voltage and/or current is above the predetermined voltage and/or current associated with a fully discharged battery, the processing arrangement 630 continues to discharge the battery 130 in step 1220. Once the sensed voltage and/or current drops to the predetermined voltage and/or current associated with a fully discharged battery, the processing arrangement 630 ceases discharging the battery 130 and exits the discharge routine in step 1230.

In addition to charging and/or discharging the battery 130 and execution of a condition cycle, the processing arrangement 630 is operable to execute at least one performance sequence to determine usage, performance, and technical support information concerning the battery arrangement 120, for example, the battery adapter 450.

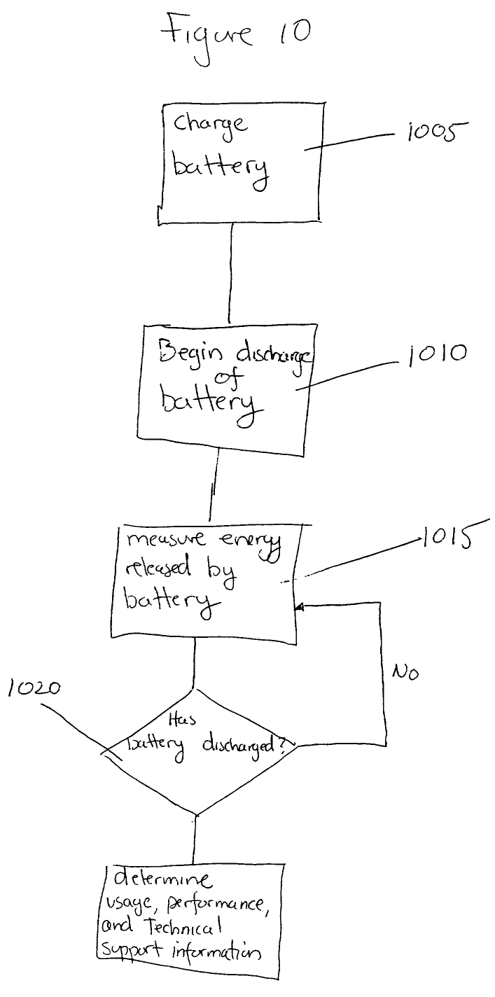

Referring now to FIG. 10, there is seen a flow diagram of an exemplary performance sequence executed by the processing arrangement 630. In step 1005, the processing arrangement 630 either charges the battery 130 or instructs the battery arrangement 120 to charge the battery 130 via the data communications arrangement 780, if the battery arrangement 120 has charging capability. In step 1010, after charging the battery 130, the processing arrangement 630 either begins discharging the battery 130 or instructs the battery arrangement 120 to begin discharging the battery 130 via the data communications arrangement, if the battery arrangement 120 has discharging capability. During step 1015, the processing arrangement 630 measures the energy released by the battery 130 by monitoring the voltage across the first and second battery contacts 466, 468 and the current flowing through the first and second battery contacts 466, 468, the current and voltage of battery 130 being communicated to the processing arrangement 630 by the current sensing arrangement 715 and the voltage sensing arrangement 720, respectively. In step, 1020, the processing arrangement 630 determines whether the battery has completed discharging. If the battery has not yet completely discharged, the processing arrangement 630 continues to monitor and accumulate measured energy data. If the battery 130 has completely discharged, the processing arrangement 630 may, in step 1025, determine usage and performance information concerning the battery 130, based at least in part on the measured and accumulated energy released from the battery 130 during the discharge measuring step 1015. The battery analyzer 105 may also generate technical support information if the usage and performance information indicate that the battery 130 is defective.

The processing arrangement 630 is also operable to transmit and receive information from the battery arrangement 120 via the data communications arrangement 780. For example, the processing arrangement may “ping” the battery arrangement 120 to determine whether the battery arrangement 120 is properly coupled to one of the analyzer ports 420. To “ping” the battery arrangement 120, the processing arrangement 630 communicates a ping-message to the battery arrangement 120 and waits for a reply. The absence of a reply indicates that the battery arrangement 120 is either busy, not properly connected, or does not exist.

The processing arrangement 630 is also operable to request status information from the battery arrangement 120 via the data communications arrangement 780. For this purpose, the processing arrangement 630 communicates a status-request message to the battery arrangement 120 via the data communications arrangement 780. The battery arrangement, for example, the battery adapter 450, may then send the status information to the processing arrangement 630 of the battery analyzer 105 via the data communications arrangement 780. The status information may indicate, for example, that the battery arrangement 120 is waiting for the battery 130 to be inserted, that the battery 130 is fully charged, that the battery arrangement 120 is waiting or is in a standby mode, that the battery arrangement 120 has a fatal error that needs correcting, that the battery arrangement is currently charging the battery 130, that the battery arrangement 120 is topping off the battery 130, and/or that the battery arrangement 120 is discharging the battery 130.

The processing arrangement 630 is also operable to read and/or write information to a memory device (not shown) situated in the battery arrangement 120 via the data communications arrangement 780. For example, the processing arrangement 630 may read old program code from the memory device of the battery arrangement 120 and/or may write new replacement program code to the memory device, as more fully described below.

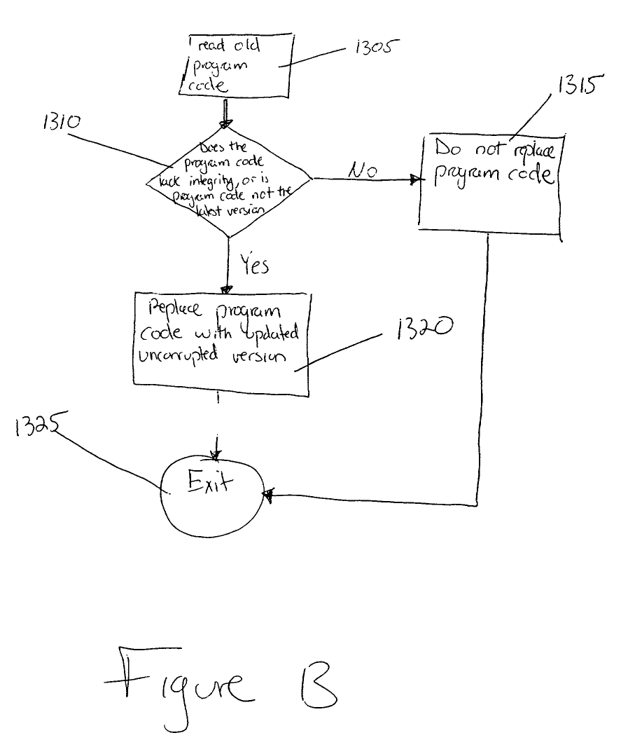

Referring now to FIG. 13, there is seen an operational sequence for receiving replacement program code from a remote device 115a, 115b, 115c, . . . , 115n for the battery arrangement 120. In step 1305, the battery analyzer 105 reads old program code from a memory device (not shown) situated in the battery arrangement 120. The program code may be configured, for example, to be executed on a micro-computer situated in the battery arrangement 120, such as the micro-computer located within the battery adapter 450 described in U.S. Patent Application attorney docket No. 02520/49401, incorporated by reference above. For this purpose, the processing arrangement 630 of the battery analyzer 105 receives the old program code via the data communications arrangement 780. The data communications arrangement 780 then communicates the old program code to the processing arrangement via the data bus 645. In step 1310, the processing arrangement 630 verifies the integrity and/or the version of the old program code. The integrity of the program code may be determined, for example, by calculating a checksum of the old program code and comparing the calculated checksum to a predetermined checksum associated with uncorrupted program code. The version of the program code may be determined from the program code itself. The processing arrangement may receive updated versions of the program code via the user interface arrangement 615, for example, from a floppy disk inserted into a floppy disk drive of the user interface arrangement 615. Alternatively, updated versions of the program code may be received from one or more of the remote devices 115a, 115b, 115c, . . . , 115n via the network interface arrangement 620. For this purpose, one or more of the remote devices 115a, 115b, 115c, . . . , 115n may communicate an updated version of the program code to the network interface arrangement 620 of the battery analyzer 105 via the computer network 110. The network interface arrangement 620 may then communicate the updated program code to the memory device 910 via the data bus 645. The processing arrangement 630, in step 1310, then compares the old program code read from the battery arrangement 120 to the updated version of the program code stored in the memory device 910. If the program code read from the battery arrangement is uncorrupted and updated, the processing arrangement 630 will not replace the program code stored on the memory device of the battery arrangement 120, as represented by step 1315. However, if the old program code is corrupted (i.e., the checksum was incorrect) and/or the version of the old program code is not the most updated version of the program code, the processing arrangement 630, in step 1320, replaces the old program code stored on the memory device of the battery arrangement 120 by communicating the uncorrupted latest version of the program code to the memory device of the battery arrangement 120 via the data communications arrangement 780. The processing arrangement 630 then exits the operational sequence in step 1325.

In addition to or in lieu of the automatic program code replacement described above, it should be appreciated that replacement of the old program code may be initiated manually by the user 635 and/or by one or more of the remote devices 115a, 115b, 115c, . . . , 115n via the computer network 110.

It should also be appreciated that the program code received from the user 635 and/or one or more of the remote devices 115a, 115b, 115c, . . . , 115n may be program code for execution on the micro-computer 905 of the battery analyzer 105. In this regard, the processing arrangement 630 may, for example, replace its own program code stored on memory unit 910 with an uncorrupted version of the program code received from the user 635 and/or one or more of the remote devices 115a, 115b, 115c, . . . , 115n.

The processing arrangement 630 is operable to store the information received from the battery arrangement 120 in the memory device 910. For example, the processing arrangement may store information relating to a charging status of the battery 130, the information relating to a discharging status of the battery 130, the information relating to a performance of the battery 130, the information relating to a usage of the battery 130, the information relating to technical support concerning the battery 130, status information of the battery arrangement 120, etc. This information may then be communicated, for example, to the user 635 via the user interface arrangement 615 and/or the at least one remote device 115a, 115b, 115c, . . . , 115n via the network interface arrangement 620.

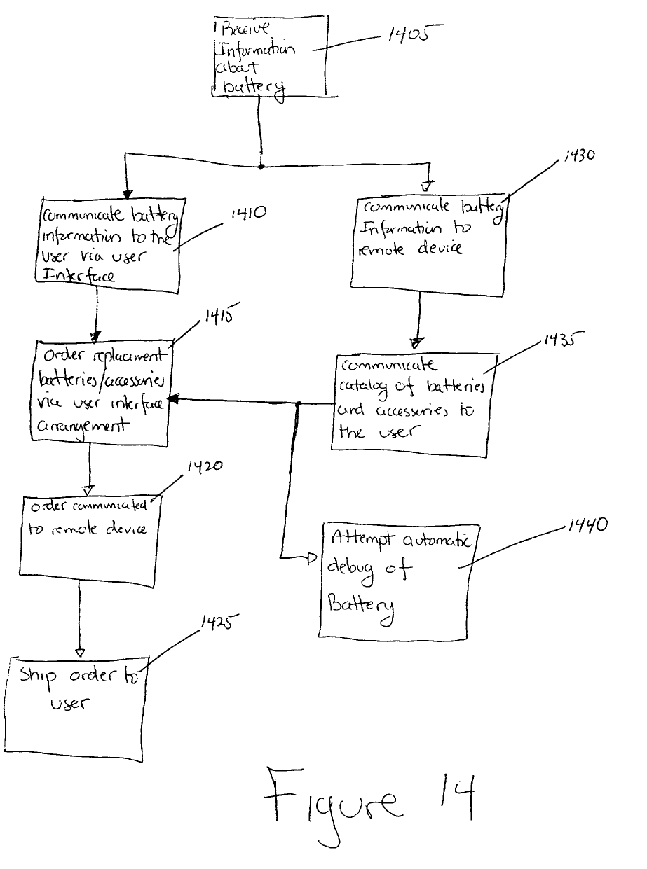

Referring now to FIG. 14, there is seen an operational sequence for communicating battery information, such as usage, performance, and technical support information, to the user 635 and/or one or more of the remote devices 115a, 115b, 115c, . . . , 115n. In step 1405, the processing arrangement 630 receives information concerning the battery 130 from the memory device 910. As described above, the processing arrangement 630 is configured to store the information received from the battery arrangement 120 in the memory device 910, such as the charging status of the battery 130, the discharging status of the battery 130, the performance of the battery 130, the usage of the battery 130, technical support information concerning the battery 130, status information of the battery arrangement 120, etc. This information may then be communicated to the user 635 in step 1410. For this purpose, the processing arrangement 630 communicates the battery information to the user interface arrangement 615 via the data bus 645. The user interface arrangement 615 then communicates the battery information to the user 635, for example, via an LCD screen as more fully described below. The user may take certain actions in accordance with the battery information. For example, the user may call the customer service site 210 and order replacement batteries if the battery information indicates the battery 130 is defective. Alternatively, the user 635 may order replacement batteries and/or accessories directly from the user interface 615, as represented by step 1415. In this regard, the user inputs an order into the user interface, for example, via a touch screen displaying a catalog of batteries and/or accessories. The order is then communicated to the network interface arrangement 620 via the data bus 645. The network interface arrangement 620 then communicates the order to one or more of the remote devices 115a, 115b, 115c, . . . , 115n via the computer network, where it is forwarded to the customer service site 210, as represented by step 1420. After the order is received by the customer service site 210, the order may be filed and then shipped to the user 635 in step 1425.

Additionally and alternatively, the battery information may be provided directly to one or more of the remote devices 115a, 115b, 115c, . . . , 115n in step 1430. The remote device 115a, 115b, 115c, . . . , 115n may then analyze the battery information and take appropriate action in accordance with the battery information concerning the battery 130. For example, if the battery information indicates that the battery 130 is defective, the remote device 115a, 115b, 115c, . . . , 115n may communicate a catalog of accessories and replacement batteries to the user 635, as represented in step 1435. In this regard, the remote device 115a, 115b, 115c, . . . , 115n may communicate digital information concerning the catalog of accessories and replacement batteries to the battery analyzer 105 via the computer network 110. The digital information concerning the catalog of accessories and replacement batteries is then received by the network interface arrangement 620 and communicated to the user interface arrangement 615, where it is displayed to the user 635, for example, via an LCD screen. After the catalog of accessories and replacement batteries is displayed to the user 635, the user 635 may, for example, order replacement batteries and/or accessories via the user interface 615 in step 1415, as described above.

Additionally or alternatively, in step 1440, the remote device 115a, 115b, 115c, . . . , 115n may attempt to diagnose the battery 130 in accordance with the battery information received from the battery analyzer 105. Based, for example, on the usage, performance, and/or technical support information received from the battery analyzer 105 via the computer network 110, the remote device 115a, 115b, 115c, . . . , 115n may determine, for example, that the first and second battery contacts 466, 468 are not connected properly to the battery arrangement 120 and/or the battery arrangement 120 is not connected properly to the battery analyzer 105. Or, for example, the remote device 115a, 115b, 115c, . . . , 115n may determine, for example, that the first and second battery contacts 466, 468 need cleaning. To facilitate proper diagnosis, the remote device 115a, 115b, 115c, . . . , 115n may communicate a set of instructions to the user 635 via the computer network 110. The instructions may be displayed to the user 635 via the user interface arrangement 615 and may instruct the user 635, for example, to clean the first and second battery contacts 466, 468 of the battery 130, check the connections between the battery 130 and the battery arrangement 120, check the connections between the battery arrangement 120 and the battery analyzer 105, etc.

It should be appreciated that the battery analyzer 105 may include program code stored on the memory device 910 operable to permit the micro-computer 905 to diagnose the battery 130 without need for remote assistance from one or more of the remote devices 115a, 115b, 115c, . . . , 115n. In this regard, the battery analyzer 105 may diagnose problems associated with the battery 130, without the need for the battery analyzer 105 to be connected to the computer network 110.

The processing arrangement is also operable to store data received from the at least one remote device 115a, 115b, 115c, . . . , 115n in the memory device 910, such as marketing information, software updates for the battery analyzer 105, user manuals, technical support data, product catalog information, battery specifications data, and/or advertising information. The data may then be displayed to the user 635 via the user interface arrangement 615 and/or may be used to automatically update the battery analyzer 105 and/or the battery arrangement 120 as described above.

The processing arrangement 630 is also operable to store user input data received from the user interface arrangement 615 in the memory device 910. The user input data may include, for example, catalog orders for batteries, orders for accessories, other user requests, as described above. The processing arrangement 630 may retrieve the user input data from the memory device 910 and, for example, communicate the user input data to the at least one remote device 115a, 115b, 115c, . . . , 115n over the computer network 110 via the network interface arrangement 620. Alternatively, the processing arrangement 630 may communicate the user input data to the at least one remote device 115a, 115b, 115c, . . . , 115n over the computer network 110, without first storing the user input data in the memory device 910.

The user interface arrangement 615 includes circuitry operable to communicate user information to the user 635 and receive user input data from the user 635. The user interface arrangement 615 may include, for example, a monochrome or color liquid-crystal display (LCD) screen with or without touch screen capabilities. The user interface arrangement 615 may also include a plurality of buttons and/or switches to perform certain functions, for example, to order products from a catalog received from the at least one remote device 115a, 115b, 115c, . . . , 115n.

If the computer network 110 includes a connection to the Internet, the memory device 910 may store, for example, browser software to be executed on the micro-computer 905. The browser software would provide the user 635 with a WEB browser via, e.g., the monochrome or color LCD screen, with which the user 635 may browse battery specifications data and order accessories and/or replacement batteries from the at least one remote device 115a, 115b, 115c, . . . , 115n, for example, from a WEB site maintained at a remote location.

The user interface arrangement 615 may also include a device operable to receive user input in a computer-formatted form, such as, a floppy disk drive, a ZIP drive, a memory-card adapter, etc. In this regard, the user 635 may download updated information to the processing arrangement 630 of the battery analyzer 105, such as replacement program code for the battery analyzer 105 and/or the battery arrangement 120, digital catalogs of replacement batteries and/or accessories to be displayed to the user 635 via the LCD screen, battery specifications to be displayed to the user 635 via the LCD screen, etc.

What is claimed is:

1. A battery analyzer, comprising:
a network interface arrangement configured to communicatively couple to a computer network;
a battery interface arrangement configured to electrically connect to at least one battery arrangement, each of the at least one battery arrangement including at least one battery; and
a processing arrangement electrically and communicatively coupled to the network interface arrangement and the battery interface arrangement; wherein the processing arrangement is configured to communicate first information concerning the at least one battery to at least one remote device via the computer network.

2. The battery analyzer according to claim 1, wherein the first information concerning the at least one battery includes at least one of usage information, performance information, technical support information, and user information.

3. The battery analyzer according to claim 1, wherein the processing arrangement is further configured to receive second information from the at least one remote device via the computer network.

4. The battery analyzer according to claim 3, wherein the second information received from the at least one remote device includes at least one of marketing information, software updates for the battery analyzer, software updates for the battery arrangement, user manuals, technical support data, product catalog information, battery specifications data, advertising information, and parameter information.

5. The battery analyzer according to claim 4, further comprising a user interface arrangement configured to communicate at least a portion of the second information to a user.

6. The battery analyzer according to claim 5, wherein the user information includes at least one of battery orders and accessory orders received from the user.

7. The battery analyzer according to claim 1, wherein the network interface arrangement is configured to connect to at least one of a dedicated point-to-point network, a token-ring network, a Wide Area Network, a Local Area Network, an intranet, an internet, and the Internet.

8. The battery analyzer according to claim 1, wherein the network interface arrangement is configured to connect to the computer network via at least one of a hardwired connection and a wireless connection.

9. The battery analyzer according to claim 8, further comprising a user interface arrangement configured to communicate at least a portion of the second information to a user.

10. The battery analyzer according to claim 1, wherein the battery interface arrangement includes a data interface arrangement configured to electrically and communicatively couple to the at least one battery arrangement; the data interface arrangement further configured to transmit third information to and receive fourth information from the at least one battery arrangement.

11. The battery analyzer according to claim 10, wherein the third data include at least one of replacement program code data, a command for the at least one battery arrangement to charge the at least one battery, a command for the at least one battery arrangement to discharge the at least one battery, a ping command, and a request for status information.

12. The battery analyzer according to claim 10, wherein the fourth data include at least one status information and program code.

13. The battery analyzer according to claim 10, wherein the first information concerning the at least one battery includes at least one of usage information, performance information, technical support information, and user information.

14. The battery analyzer according to claim 13, wherein the processing arrangement is further configured to receive second information from the at least one remote device via the computer network.

15. The battery analyzer according to claim 14, wherein the second information received from the at least one remote device includes at least one of marketing information, software updates for the battery analyzer, software updates for the battery arrangement, user manuals, technical support data, product catalog information, battery specifications data, advertising information, and parameter information.

16. The battery analyzer according to claim 8, further comprising a user interface arrangement configured to communicate at least a portion of the second information to a user, the user information including at least one of product orders, user requests, and user inquiries.

17. The battery analyzer according to claim 1, wherein the battery interface arrangement includes a smart-battery interface configured to electrically and communicatively couple to a smart battery.

18. The battery analyzer according to claim 17, wherein the network interface arrangement is configured to connect to the computer network via at least one of a hardwired connection and a wireless connection.

19. The battery analyzer according to claim 17, wherein the first information concerning the at least one battery includes at least one of usage information, performance information, technical support information, and user information.

20. The battery analyzer according to claim 17, wherein the processing arrangement is further configured to receive second information from the at least one remote device via the computer network.

21. The battery analyzer according to claim 20, wherein the second information received from the at least one remote device includes at least one of marketing information, software updates for the battery analyzer, software updates for the battery arrangement, user manuals, technical support data, product catalog information, battery specifications data, advertising information, and parameter information.

22. The battery analyzer according to claim 1, wherein the battery interface arrangement is configured to sense at least one of a current of the at least one battery, a voltage of the at least one battery, a temperature of the at least one battery, and a chemistry of the at least one battery.

23. The battery analyzer according to claim 1, wherein the processing arrangement is configured to initiate a performance sequence.

24. The battery analyzer according to claim 1, wherein the processing arrangement is configured to initiate a performance sequence in accordance with the current of the at least one battery, the voltage of the at least one battery, the temperature of the at least one battery, and the chemistry of the at least one battery

25. The battery analyzer according to claim 1, wherein the processing arrangement is configured to initiate a condition cycle.

26. The battery analyzer according to claim 22, wherein the network interface arrangement is configured to connect to the computer network via at least one of a hardwired connection and a wireless connection.

27. The battery analyzer according to claim 22, wherein the first information concerning the at least one battery includes at least one of usage information, performance information, technical support information, and user information.

28. The battery analyzer according to claim 22, wherein the processing arrangement is further configured to receive second information from the at least one remote device via the computer network.

29. The battery analyzer according to claim 28, wherein the second information received from the at least one remote device includes at least one of marketing information, software updates for the battery analyzer, software updates for the battery arrangement, user manuals, technical support data, product catalog information, battery specifications data, advertising information, and parameter information.

30. A battery analyzer, comprising:
a network interface arrangement configured to communicatively couple to a computer network;
a battery interface arrangement configured to electrically connect to at least one battery arrangement, each of the at least one battery arrangement including a battery; and
a processing arrangement electrically and communicatively coupled to the network interface arrangement and the battery interface arrangement; wherein the processing arrangement is configured to communicate first information concerning a diagnosis of the at least one battery to at least one remote device via the computer network.

31. The battery analyzer according to claim 30, wherein the first information concerning a diagnosis of the at least one battery includes at least one of usage information, performance information, technical support information, and user information.

32. The battery analyzer according to claim 30, wherein the processing arrangement is further configured to receive second information from the at least one remote device via the computer network.

33. The battery analyzer according to claim 32, wherein the second information received from the at least one remote device includes at least one of marketing information, software updates for the battery analyzer, software updates for the battery arrangement, user manuals, technical support data, product catalog information, battery specifications data, advertising information, and parameter information.

34. The battery analyzer according to claim 30, wherein the network interface arrangement is configured to connect to at least one of a dedicated point-to-point network, a token-ring network, a Wide Area Network, a Local Area Network, an intranet, an internet, and the Internet.

35. The battery analyzer according to claim 30, wherein the network interface arrangement is configured to connect to the computer network via at least one of a hardwired connection and a wireless connection.

36. The battery analyzer according to claim 30, wherein the battery interface arrangement includes a data interface arrangement configured to electrically and communicatively couple to the at least one battery arrangement; the data interface arrangement further configured to transmit third information to and receive fourth information from the at least one battery arrangement.

37. The battery analyzer according to claim 36, wherein the third data include at least one of replacement program code data, a command for the at least one battery arrangement to charge the at least one battery, a command for the at least one battery arrangement to discharge the at least one battery, a ping command, and a request for status information.

38. The battery analyzer according to claim 36, wherein the fourth data include at least one status information and program code.

39. The battery analyzer according to claim 30, wherein the battery interface arrangement includes a smart-battery interface configured to electrically and communicatively couple to a smart battery.

40. The battery analyzer according to claim 30, wherein the battery interface arrangement is configured to sense at least one of a current of the at least one battery, a voltage of the at least one battery, a temperature of the at least one battery, and a chemistry of the at least one battery.

41. The battery analyzer according to claim 30, wherein the processing arrangement is configured to initiate a performance sequence.

42. The battery analyzer according to claim 30, wherein the processing arrangement is configured to initiate a performance sequence in accordance with the current of the at least one battery, the voltage of the at least one battery, the temperature of the at least one battery, and the chemistry of the at least one battery

43. The battery analyzer according to claim 30, wherein the processing arrangement is configured to initiate a condition cycle.

44. A battery analyzer, comprising:
a network interface arrangement configured to communicatively couple to a computer network;
a battery interface arrangement configured to electrically connect to at least one battery arrangement, each of the at least one battery arrangement including a battery; and
a processing arrangement electrically and communicatively coupled to the network interface arrangement and the battery interface arrangement; wherein the processing arrangement is configured to control at least one of a charging and a discharging of the at least one battery as a function of information received from at least one remote device via the network interface.

45. The battery analyzer according to claim 44, wherein the information received from the at least one remote device includes at least one of charging and discharging parameters.

46. The battery analyzer according to claim 44, wherein the information received from the at least one remote device includes program code for execution on at least one of the battery arrangement and the battery analyzer.

47. A battery analyzer system, comprising:
a computer network;
a battery analyzer including a network interface arrangement communicatively coupled to the computer network, a battery interface arrangement configured to electrically connect to at least one battery arrangement, each of the at least one battery arrangement including a battery, and a processing arrangement electrically and communicatively coupled to the network interface arrangement and the battery interface arrangement; and
at least one remote device communicatively coupled to the computer network; wherein the processing arrangement of the battery analyzer is configured to communicate first information concerning the at least one battery to the least one remote device via the computer network.

48. The battery analyzer according to claim 47, wherein the first information concerning the at least one battery includes at least one of usage information, performance information, technical support information, and user information.

49. The battery analyzer according to claim 47, wherein the processing arrangement is further configured to receive second information from the at least one remote device via the computer network.

50. The battery analyzer according to claim 49, wherein the second information received from the at least one remote device includes at least one of marketing information, software updates for the battery analyzer, software updates for the battery arrangement, user manuals, technical support data, product catalog information, battery specifications data, advertising information, and parameter information.

51. A customer service site, comprising:
a network interface arrangement configured to communicatively couple to a computer network; and
a processing arrangement electrically and communicatively coupled to the network interface arrangement; wherein the processing arrangement is configured to communicate first information concerning the at least one battery to the at least one battery analyzer via the computer network, and the processing arrangement is further configured to receive second information concerning at least one battery from at least one battery analyzer via the computer network.

52. The battery analyzer according to claim 51, wherein the first information concerning the at least one battery includes at least one of usage information, performance information, technical support information, and user information.

53. The battery analyzer according to claim 49, wherein the second information includes at least one of marketing information, software updates for the battery analyzer, software updates for the battery arrangement, user manuals, technical support data, product catalog information, battery specifications data, advertising information, and parameter information.

54. A method of communicating information concerning at least one battery to at least one remote device, the method comprising:
determining first information concerning the at least one battery; and
transmitting the first information concerning the at least one battery to the at least one remote device via a computer network.

55. The method according to claim 54, wherein the first information concerning the at least one battery includes at least one of usage information, performance information, technical support information, and user information.

56. The method according to claim 55, further comprising the step of receiving second information from the at least one remote device via the computer network.

57. The method according to claim 56, wherein the second information received from the at least one remote device includes at least one of marketing information, software updates for a battery analyzer, software updates for a battery arrangement, user manuals, technical support data, product catalog information, battery specifications data, advertising information, and parameter information.

58. The method according to claim 56, further comprising the step of communicating at least a portion of the second information to a user.

59. The method according to claim 56, wherein the user information includes at least one of battery orders and accessory orders received from the user.
